(19) United States
(12) Patent Application Publication
(10) Pub. No.: US 2026/0255102 A1
(43) Pub. Date: Aug. 27, 2026

(54) TUNABLE ACOUSTIC ZONE DETECTION

(71) Applicant: CERENCE OPERATING COMPANY, Burlington, MA (US)

(72) Inventors: Tobias WOLFF, Burlington, MA (US); Kaspar MULLER, Burlington, MA (US); Simon GRAF, Burlington, MA (US); Timo MATHEJA, Burlington, MA (US)

(21) Appl. No.: 19/160,206

(22) PCT Filed: Mar. 2, 2023
(86) PCT No.: PCT/US2023/014345

§ 371 Date: Aug. 27, 2025

(51) Int. Cl. H04R 3/00; H04R 1/40

(52) U.S. Cl. CPC H04R 3/005; H04R 1/406; H04R 2499/13

(57) ABSTRACT

A tunable zone detection approach makes use of multiple microphones in a fixed configuration in an environment. There are multiple zones in the environment and one or more predetermined positions in each zone. Predetermined transfer functions between the positions and the microphones are used to determine beamformed energies for each of the positions based on received microphone signals. These beamformed energies may be computed using normalization of correlations between microphones. The beamformed energies are processed using a tunable transformation to determine whether an acoustic source is in a particular zone, thereby enabling adjustment of the detection approach to situations including variation in acoustics of the environment.

### BACKGROUND

This invention relates to detection and localization of acoustic sources, and in particular relates to acoustic zone detection of a source such as a speaking subject.

In order to interact with subjects who may be speaking in different zones of an environment, it can be effective to determine the zone of the speaker, for example, to configure or control a voice interface, such as for a voice assistant or a voice communication system. For example, in the case of an in-vehicle environment, the zone may correspond on one of a set number of different seating locations in the vehicle.

### SUMMARY

In one aspect, in general, a method for acoustic processing for an environment make use of a plurality of microphones in a fixed configuration that provides a plurality of microphone signals sensing the environment. The environment has a fixed predetermined plurality of positions (i.e., physical locations, optional associated with directions) and a predetermined plurality of zones (e.g., physical regions) with each zone having one of more of the positions located within it. The acoustic processing includes detecting an acoustic source in a predetermined zone of the environment. The detecting of the acoustic source includes receiving the plurality of microphone signals, and then processing those signals to determine phase and amplitude relationships among pairs of the microphone signals at a plurality of frequencies. These relationships among the pairs of microphones are processed according to a parameterized beamforming process to yield a frequency representation of a beamformed energy for each of the positions in the environment. A parametric (e.g., “tunable”) transformation is then applied to the frequency representations of beamformer energies for each position to yield a plurality of indicator values, with each indicator value associated with a respective predetermined zone. The parametric transformation configured with values of parameters determined according to performance of zone detection for the environment. A determination that an acoustic source is in a particular zone is made according to the indicator value associated with said zone.

Aspects can include combinations of one or more of the following features.

Each of the positions in the environment has a respective fixed physical location (e.g., three-dimensional coordinates) in the environment. In some examples, at least some of the positions have a respective orientation (i.e., a direction of source emission) in the environment.

Applying the parametric transformation to the frequency representations of beamformer energies comprises, for at least one zone having multiple positions located within it, combining the frequency representations of beamformer energies for said positions.

Processing the plurality of microphone signals comprises processing successive time segments of the microphone signals, and the determining that an acoustic source is in a particular zone is repeated for multiple of said time segments.

The determine of the phase and amplitude relationships among pairs of the microphone signals comprises determining said relationships for a time segment based on microphone signals of said time segment and one or more prior time segments (e.g., by averaging over multiple segments).

The determining of values of parameters of the parameterized beamforming process includes determining the transfer functions from each position of the plurality of positions to each microphone signal of the plurality of microphone signals.

The determining of the values of the parameters of the parameterized beamforming process is performed prior to the receiving of the plurality of microphone signals. In some examples, the determining of the values of the parameters of the parameterized beamforming process is based at least in part on an analytical acoustic model of the environment. Alternatively or in addition, the determining of the values of the parameters of the parameterized beamforming process is based experimental data collection in an environment with physical characteristics corresponding to the environment in which the acoustic source is detected (e.g., in an environment of the same physical dimensions and microphone placements).

The determining of the values of the parameters of the parameterized beamforming process comprises computing steering values between pairs of microphone signals for each position of the plurality of positions. In some examples, the computing of the steering values between pairs of microphone signals comprises computing said steering values for a subset of fewer than all the pairs of microphone signals (e.g., certain pairs of microphones are not considered for one or more positions). In some examples, the computing of the steering values between pairs of microphone signals comprises magnitude normalizing the steering values.

The method further includes determining values of the parameters of the parameterized transformation of the frequency representations of beamformer energies for each position based at least in part on data comprising examples of microphone signals associated with respective known source zones collected in an environment with physical characteristics corresponding to the environment in which the acoustic source is detected.

The determining of the values of the parameters of the parameterized transformation is performed prior to the receiving of the plurality of microphone signals.

The method further includes determining values of the parameters of the parameterized transformation of the frequency representations of beamformer energies for each position using an adaptive procedure (e.g., recursive least squares, RLS) using microphone signals previously collected in the environment in which the acoustic source is detected.

The acoustic environment includes a cabin of a vehicle and may further include at least one zone outside the vehicle.

In another aspect, in general, an acoustic processing system is configured to perform all the steps of any one of the methods set forth above.

In another aspect, in general, a non-transitory machine-readable medium comprises instructions stored thereon, where executing the instructions on a data processor causes the processor to perform all steps of any one of the methods set forth above.

An advantage of tuning of the transformation of the frequency representations of beamformer energies is accommodation of variation in acoustics of the environment (e.g., physical dimensions, surface reflections, reverberation, noise), which can improve the performance of the zone detection. Another advantage is that the tuning can enable consideration of a limited number of positions in each zone rather than having to determine beamformer energies over entire zones in the environment, thereby reducing the computational requirements.

Other features and advantages of the invention are apparent from the following description, and from the claims.

### BRIEF DESCRIPTION OF THE DRAWINGS

FIG. 1 is a schematic side view of a vehicle with multiple microphones for monitoring the in-vehicle environment;

FIG. 2 is schematic to view of the vehicle an acoustic processing system;

FIG. 3 is a schematic diagram of a speaker zone detector;

### DETAILED DESCRIPTION

Referring to FIG. 1, a vehicle is configured with a number of microphones 132, 133, located within the vehicle environment 130 (e.g., the cabin, optionally also including microphones outside the vehicle, not shown) which receive acoustic signals including speech produced by occupants 120. The microphones provide signals to an audio system 136, which can pass those signals to a variety of audio- or voice-based systems in the vehicle (or remote from the vehicle), such as a voice interface 140 for a voice-based assistant. Other systems that use microphone signals may include communications systems allowing the occupants to interact by voice with remote people (e.g., by telephone), and in-vehicle communication systems that may enhance voice communication between occupants, for example usings speakers 133. The audio system 136 also provides the microphone signals to a speaker zone detector 100, which determines zones in the vehicle, if any, from which an occupant (also referred to below as a “user”) is speaking.

The speaker zone detector 100 is used to determine a source zone of user speech in the vehicle environment 130. Such a determination may be then used in the process controlling an audio interaction with a user, for example, for use in triggering an interaction when speech is detected, controlling directionality of acoustic signal acquisition and/or audio signal presentation for an audio interaction, or controlling a dialog according to a location of a speaker, for instance if multiple people may speak in the vehicle or the nature of the audio interaction may depend on the location of the speaker (e.g., a driver location vs a passenger location).

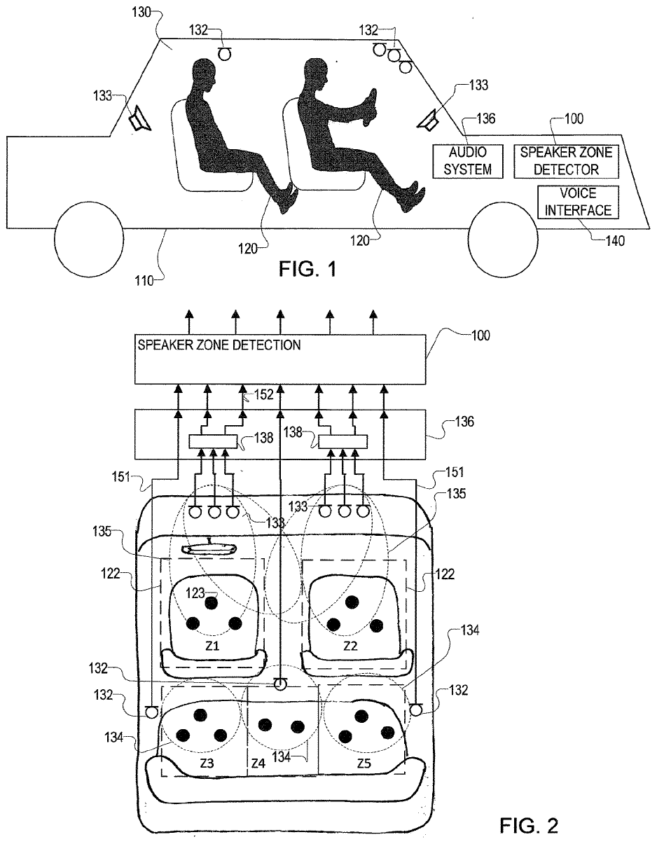

Referring to FIG. 2, one aspect the system is that there are, in general, a limited set of predetermined source zones, for example, zones 122, labelled Z1 to Z5 corresponding to five seating locations in the vehicle cabin. In the discussion below, there are Z such predetermined source zones, with Z=5 in the illustration of FIG. 2. In at least some embodiments, a goal of the system is to determine from which, if any, of these zones user speech is originating.

Another aspect of the system is that, in general, it is configurable to different vehicle environments, different arrangements of microphones and/or different specifications of zones in the environment (e.g., in size, location, typical speaker orientation, etc.). In FIG. 1, a total of nine microphones 132, 133 are shown. In the illustration of FIG. 1, three microphones 132 have corresponding direction response patterns 134 (e.g., generally omnidirectional patterns) and these microphones provide electrical microphone signals 151 representing the received acoustic signals. Optionally, some microphones are subject to fixed array processing. For example, three microphones 133 (e.g., three microphones near a driver position Z1) may be processed to yield two audio signals 152 using an array processor 138. For example, two different delay-and-sum beamformers are used to form two directional response patterns 135 corresponding to each of the audio signals 152, respectively. The microphone signals 151 and processed audio signals 152 are treated as fixed acoustic sensors of the vehicle environment, and are processed together as inputs to a steered response power processor 112. In the discussion below, these microphone and audio signals are denoted x₁ through x_{M} for M=7 in the arrangement of FIG. 1. That is, the set of physical microphones generate a set of M microphone signals, each of which is associated with a particular spatial response pattern in the vehicle.

The speaker zone detector 100 addresses a task of determining a zone from which the speaker is speaking. Approaches below make use of one or more representative positions (i.e., a predetermined finite enumerated set) within (i.e., associated with) respective zones. In the description below, there are P such positions. In general, each position is associated with a particular physical location of a speaker in the environment, for example, represented by three (or in some implementations, two) coordinates in physical dimensions. Each of these positions is denoted by a position index, 1≤p≤P. In FIG. 2, P=14 positions 123 are illustrated, with each zone having two or three positions.

Optionally, each of the enumerated positions is, in addition to its physical location, associated with a direction or orientations. When referred to below explicitly, the direction is denoted by a direction index d from a set of D representative directions. Furthermore, references to a “position” below may therefore be optionally replaced below by a reference to a “pose” (p, d) representing both the source physical location and the direction of the source. That is, that than there being P positions, there are P×D poses.

For a particular position p in the vehicle environment 130 and an m^{th} microphone signal xₘ 151, 152, the acoustic and signal processing path for a source signal s originating at that position to the microphone signal xₘ can be represented (e.g., approximated) as a linear transfer function gₘ. In the frequency domain, the effect of the acoustic path may be represented as xₘ(k)=gₘ(k, p)s(k), for the k^{th} frequency index of K frequencies, for example, computable via a Fourier Transform (e.g., a Fast Fourier Transform, FFT). That is, there is a different transfer function for each combination of a source position and a microphone signal. Note that these transfer functions in general represent both a gain and a phase at each frequency k (which may be represented as a complex quantity), where both amplitude and phase may be significant in localization because differences in acoustic propagation distance may be manifesting in both magnitude and phase differences. There are a variety of ways of estimating or approximating these transfer functions, including by experimental data collection (e.g., using a physical acoustic environment, anatomically accurate dummies to emit recorded speech, etc.), or by analytical acoustic signal propagation techniques. In both experimental and analytical techniques, one should recognize that these determined transfer functions may not be exact, and may not match effects of varying numbers of passengers in a vehicle, reverberation effects, non-ideal user seating positions, etc. Nevertheless, in embodiments described below, these M×P transfer functions gₘ(k, p) are assumed to be known and fixed for a particular vehicle configuration.

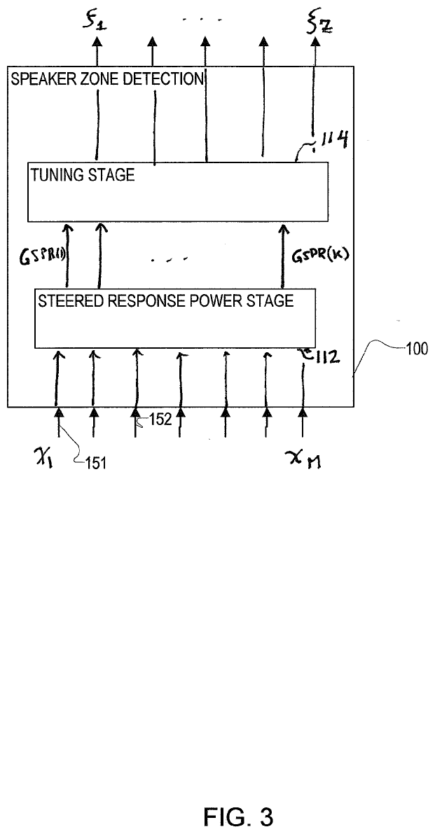

Referring to FIG. 3, the speaker zone detector 100 receives the M microphone signals 151, 152 and produces Z (the number of zones) indicators of speech presence in corresponding zones, for example, representing a probability distribution over the possible zones, or Z separate indicators likelihood of speech originating from each of the zones. In an embodiment described below, this zone detector 100 comprises two processing stages: a steered response power (SRP) stage 112, and a tuning transform stage 114. As described below, the steered response power stage 112 is configured according to the transfer functions gₘ(k, p), and the tuning transform 114 is tuned according to experimental or synthesized data for speech in the vehicle environment.

Processing of the microphones is specified below using mathematical notation. While such processing may be performed in digital form after analog-to-digital conversion (e.g., on a numerical processor) other implementations may perform the operations in analog form and/or in approximations of the mathematical specification may be used. In general, italics lower and upper case represent scalar (possibly complex) quantities, such as a or A. A superscript * represents a complex conjugate. Vectors are generally represented as columns and denoted with an underline, such as a or A. Finally, matrices are generally represented in upper case non-italics, for example, as A or Φ. A superscript T denotes a vector or matrix transpose, and a superscript H denotes a transpose of a complex-conjugate.

The SRP stage 112 illustrated in FIG. 1 receives M microphone signals 151, 152 and outputs P SRP signals 161. The SRP stage may be implemented in the frequency domain where a microphone time signal xₘ(t) is processed in successive time sections (e.g. “windows” or “frames”) and each section is processed to yield a Fourier Transform xₘ(k), for k=0, . . . , K−1, which is a complex function (i.e., representing magnitude and phase) of frequency k. The processing below describes the processing of one such time section understanding that the processing is repeated for successive time sections. For each frequency index k, the microphone signals may be arranged as a vector

$$\underline{x} ( k ) = {[ {x}_{1} ( k ) , {x}_{2} ( k ) , … , {x}_{M} ( k ) ]}^{T} .$$

A matrix of spatial correlations (M×M complex quantities) is computed for this time section for each frequency index as x(k)x^{H}(k), and a smoothed estimate of the spatial correlation is updated as

$${Φ}_{x x}^{n e w} ( k ) := {Φ}_{x x}^{old} ( k ) + ( 1 - α ) \underline{x} ( k ) {\underline{x}}^{H} ( k ) ,$$

where α∈[0, 1) is chosen to adjust how quickly the system updates with smoothed estimate. The current smoothed estimate is referred to as Φₓₓ below, and the (m, n) entry is denoted φₓ_{ₘ}ₓ_{ₙ}.

An optional step is to zero-out (i.e., set to zero) certain entries in the smoothed estimate Φₓₓ by elementwise, φₓ_{ₘ}ₓ_{ₙ}_{,subset}=φₓ_{ₘ}ₓ_{ₙ}ψₘₙ, for all 1≤m, n≤M, where ψₘₙ∈{0, 1}. This masking may be denoted in matrix notation as subsetted smoothed spatial correlation Φ_{xx,subset} (k)=Φₓₓ(k)°Ψ. As discussed further below, one reason to zero out certain terms is that the corresponding pair of microphone signals may not provide useful information in the relative phase and/or magnitude, for example because of the distance between the microphones, and the system may be more robust with a zero in those positions rather than small random quantities.

A next step is to scale the subsetted smoothed spatial correlation separately for each frequency index k to yield correlation matrices whose square root of the sum of squared entries (which may be referred to as the “Frobenius norm” of the matrices) is 1. This operation can be represented as computation of the norm as

$${‖ {Φ}_{x x , s u b s e t} ( k ) ‖}_{F} = \sqrt{{\sum }_{m = 1}^{M} {\sum }_{n = 1}^{M} {\vert {Φ}_{{x}_{m} {x}_{n} , s u b s e t} ( k ) \vert}^{2}}$$

and then performing the division

$${\tilde{Φ}}_{{x}_{m} {x}_{n}} ( k ) = \frac{{Φ}_{{x}_{m} {x}_{n} , s u b s e t} ( k )}{{‖ {Φ}_{x x , s u b s e t} ( k ) ‖}_{F}} ,$$

for all m, n, which can be represented in a elementwise matrix division

$${\tilde{Φ}}_{xx} ( k ) = \frac{{Φ}_{x x , s u b s e t} ( k )}{{‖ {Φ}_{x x , s u b s e t} ( k ) ‖}_{F}} .$$

This term is referred to as the normalized smoothed spatial correlation.

Having computed the normalized spatial correlation matrix for each frequency index (i.e., for each pair of microphone signals), the next step is to compute a “beamformer” energy (i.e., the squared magnitude of a complex-valued beamformer signal) at each frequency index for each of the positions (or more generally for each of the poses being position-orientation pairs). This step makes use of a set of precomputed beamformer weights, which includes complex quantities wₘ(k, p) for each microphone m, position p, and frequency k combination. Precomputing of these weights is addressed later in this document. These quantities can be arranged in a vector notation as w(k, p)=[w₁(k, p), w₂(k, p), . . . , w_{M}(k, p)]^{T}. A steering matrix (i.e., a set of steering values for pairs of microphones) can be defined for each position p as W(k, p)=w(k, p)w^{H}(k, p). The steering matrix is subsetted and magnitude normalized using the same sequence of operations applied to the spatial correlation matrix as described above:

$${W}_{s u b s e t} ( k , p ) = W ( k , p ) °Ψ , and$$

$$\tilde{W} ( k , p ) = \frac{{W}_{s u b s e t} ( k , p )}{{‖ {W}_{s u b s e t} ( k , p ) ‖}_{F}} .$$

Finally, the beamformer energy for each position p and frequency k is computed as

$${Φ}_{y y} ( k , p ) = {\sum }_{m = 1}^{M} {\sum }_{n = 1}^{M} {\tilde{Φ}}_{{x}_{m} {x}_{n}} ( k ) \cdot {\tilde{W}}_{mn}^{*} ( k , p ) .$$

In a first approach to zone detection, the frequency and position dependent beamformer energies, Φ_{yy}(k, p), are weighted summed across frequency to yield frequency integrated beamformer values

$$GSRP ( p ) = {\sum }_{k = 0}^{K - 1} κ ( k ) \cdot {Φ}_{yy} ( k , p ) ,$$

where κ(k)∈ [0,1] is a real-valued weighting for frequency index k. For example, this weighting may be zero at frequencies where no or little speech energy is found, and therefore at which little directional information may be extracted.

As introduced above, there are in general more positions than there are zones, and each position is associated with a particular zone. This association (e.g., assignment) is denoted z= [symbol] (p) where z is the zone of position p. (Note that when an orientation d is also used, then the assignment function is the same for all orientations at a particular location). Each zone z has a predetermined function [symbol] applied to some or all the frequency weighted beamformer values and associated zone assignments for all positions to yield a corresponding value [symbol] . One use of these values is to declare that there is speech activity in zone z if [symbol] exceeds a threshold.

These zone functions [symbol] can have various forms. One choice is as a zone-specific linear combination of all GSRP(p) terms for all p. In this case all [symbol] =[ [symbol] , . . . , [symbol] ]^{T}. can be represented by a Z×P matrix that combines all P·D values of GSRP(p) for all p, stacked in one vector, to Z zone output values.

Another choice is a function of all GSRP(p) for all p with [symbol] (p)=z, i.e., a function of all GSRP samples that are assigned to zone z. An example would be to take the maximum GSRP value of all sampled source locations (and directions) assigned to zone z:

$${𝒫}_{𝓏} = {max}_{p : ζ ( p ) = 𝓏} G S R P ( p ) .$$

There are yet other choices for the functions, for instance, based on multiple logistic regression, or feedforward neural networks (e.g., multi-layer perceptrons).

In a second approach, integration over frequency is deferred and zone and frequency specific (i.e., “narrowband”) functions [symbol] (k) at each frequency in a like manner as described above, yielding corresponding values [symbol] (k). Thus, there are Z tuning functions P₁(k), P₂(k), . . . , P_{Z}(k) for each frequency bin k. The values ξ_{z}(k) are then integrated over frequency, again in a weighted manner according to the weights κ(k):

$${ξ}_{𝓏} = {\sum }_{k = 0}^{K - 1} κ ( k ) \cdot {ξ}_{𝓏} ( k )$$

for all z.

There at least two stages of precomputation. A first stage involves computing the beamformer weights w introduced above. A second stage involves computing the functions P_{z} introduced above. This second stage can be referred to as a “tuning” stage. The tuning stage can optionally further involve determining the correlation mask Ψ, and/or frequency weightings κ.

One approach for the first stage makes use of the transfer functions gₘ(k, p) from a source at the p^{th} position (or pose) to the m^{th} microphone signal, at the k^{th} frequency as introduced earlier in this document. For a particular frequency and position, a vector of gains g(k, p)=[g₁(k, p), g₂(k, p), . . . , g_{M}(k, p)]^{T} is defined, and in this approach, the beamformer weights are precomputed as

$$\underline{w} ( k , p ) = \frac{\underline{g} ( k , p )}{‖ \underline{g} ( k , p ) ‖}$$

where [symbol] denotes a Euclidean (L₂) norm.

In a second approach, the first stage further makes use of a noise or reverberation model, for instance using M×M×K complex noise power spectral density (PSD) estimates, Φvₙvₘ, (k), of the noise signals vₘ(k) and vₙ(k) in the m^{th} and n^{th} microphone signals for all m, n. The complex PSDs are represented by a M×M noise PSD matrix Φᵥᵥ(k) for every k. In this approach, the beamformer weights may be computed as

$$\underline{w} ( k , p ) = \frac{{Φ}_{vv}^{- 1} ( k ) \underline{g} ( k , p )}{{\underline{g}}^{H} ( k , p ) {Φ}_{vv}^{- 1} ( k ) \underline{g} ( k , p )} .$$

In variants of the second approach, the noise may be monitored at runtime, for example, when people are not speaking in the car and/or reverberation may be monitored during their speech. In such variants, the noise PSD matrix is estimated during runtime, and the beamformer weights are updated accordingly.

The second stage includes estimating parameter values for the functions [symbol] . The set of parameters to be estimated is denoted by θ_{P}. Value of these parameters are determined using training data including indicators d=(d₁, d₂, . . . , d_{Z}) whose elements take on 0.0 or 1.0 value according to the true position of the source, and corresponding frequency and position dependent beamformer values, Φ_{yy}(k, p) that are based on measurement or physical based simulation of the environment (e.g., taking into account near- and far-field effects, head shadowing, etc.). For particular values of parameters θ_{P}, the functions P_{z}, based on the beamformer values, Φ_{yy}(k, p) yield an output \hat{d}_{θ}_{_{P}} and the values of the parameters are varied to minimize some cost (e.g., loss) function c(d, \hat{d}). For example this cost may be a mean squared cost defined as

$$c ( d , \hat{d} ) = {\sum }_{i} {( {d}_{i} - {\hat{d}}_{i} )}^{2} .$$

In some examples introduced above, the functions P_{z} are linear, and the loss function is quadratic, and therefore solution to the optimal parameters values may be determined using a closed-form expression. With different functional forms and different loss functions, other approaches may be used, for example, determining the values of the parameters using a iterative updating procedure, which may be based on a gradient descent approach. Such updating may be done independently for each frequency, or a joint optimization may be used.

While this tuning approach is described above in the context of having labelled data with indicators of the true zone of the speaker, similar approaches may be used to adapt the tuning based on speech that is received at runtime, for example, in a decision-directed approach. The “truth” of the indicator may be based on the runtime zone detection approach, possibly augmented with other information such as dialog states, or use of a temporal zone-change model. Also, optimization of parameter values can be done using real speech recordings from a car with a recursive least squares (RLS) algorithm to incorporate new recordings into the optimization.

As introduced above, there are yet other parameters that may be tuned, namely the correlation mask Ψ, and/or frequency weightings κ. One approach to optimizing the frequency weights is to include them in an iterative updating approach based on gradients. Estimation of the correlation mask can be based on various approaches. For example, a threshold value for the entries of W(k, p) may be estimated, and the mask set according to whether the entries exceed that threshold. Other combinatorial optimization approaches may be used to select the entries to rely upon, for example, an iterative approach using genetic algorithms may be used.

While described above largely in the context of zone detection in the cabin of a vehicle, it should be understood that zones and/or microphones on the outside of the vehicle could be used, thereby allowing detection of a speaker outside the vehicle potentially relying on interior as well as exterior microphones. Also, the approach is not limited to vehicle applications, and can be used in zone detection for instance in buildings, such as in residential rooms with voice assistants or office conference rooms where zones may be associated with video conference participants.

The approaches described above may be implemented in hardware, in software, or in a combination of hardware and software. Such hardware may include application-specific integrated circuits (ASICs) and field-programmable gate arrays (FPGAs). Software can include instructions stored on a non-transitory machine-readable medium and the system may include a processor (e.g., a physical processor with a central processing unit) that executes the instructions to perform the approaches.

A number of embodiments of the invention have been described. Nevertheless, it is to be understood that the foregoing description is intended to illustrate and not to limit the scope of the invention, which is defined by the scope of the following claims. Accordingly, other embodiments are also within the scope of the following claims. For example, various modifications may be made without departing from the scope of the invention. Additionally, some of the steps described above may be order independent, and thus can be performed in an order different from that described.

1. A method for acoustic processing in an environment in which a plurality of microphones is in a fixed configuration that provides a plurality of microphone signals sensing the environment, the environment having a fixed predetermined plurality of positions and a plurality of predetermined zones with each zone having one of more of said positions located within it, wherein the acoustic processing includes detecting of an acoustic source in a predetermined zone of the environment, the detecting of the acoustic source comprising:
receiving the plurality of microphone signals;
processing the plurality of microphone signals to determine at least one of a phase and an
amplitude relationship among pairs of the microphone signals at a plurality of frequencies;
processing the relationships among the pairs of microphones according to a parameterized beamforming process to yield a frequency representation of a beamformed energy for each position of the plurality of positions in the environment; and
determining that an acoustic source is in a particular zone according to the beamformed energy of each of the positions.

2. The method of claim 1, wherein the acoustic environment comprises a cabin of a vehicle.

3. The method of claim 2, wherein the acoustic environment comprises at least one zone outside the vehicle.

4. The method of claim 1, further comprising applying a parametric transformation to the frequency representations of beamformer energies for each position to yield a plurality of indicator values, each indicator value associated with a respective predetermined zone, the parametric transformation being configured with values of parameters determined according to performance of zone detection for the environment, and wherein the determining that the acoustic source is in a particular zone is based on the indicator value associated with said zone.

5. The method of claim 1, wherein each of the positions in the environment has a respective fixed physical location in the environment.

6. The method of claim 5, wherein each position of at least some of the positions has a respective orientation in the environment.

7. The method of claim 4, wherein applying the parametric transformation to the frequency representations of beamformer energies comprises, for at least one zone having multiple positions located within it, combining the frequency representations of beamformer energies for said positions.

8. The method of claim 4, further comprising determining values of the parameters of the parameterized transformation of the frequency representations of beamformer energies for each position based at least in part on data comprising examples of microphone signals associated with respective known source zones collected in an environment with physical characteristics corresponding to the environment in which the acoustic source is detected.

9. The method of claim 8, wherein the determining of the values of the parameters of the parameterized transformation is performed prior to the receiving of the plurality of microphone signals.

10. The method of claim 4, further comprising determining values of the parameters of the parameterized transformation of the frequency representations of beamformer energies for each position using an adaptive procedure using microphone signals previously collected in the environment in which the acoustic source is detected.

11. The method of claim 1, wherein processing the plurality of microphone signals comprises processing successive time segments of the microphone signals, and the determining that an acoustic source is in a particular zone is repeated for multiple of said time segments.

12. The method of claim 1, wherein the determine of the phase and amplitude relationships among pairs of the microphone signals comprises determining said relationships for a time segment based on microphone signals of said time segment and one or more prior time segments.

13. The method of claim 1, further comprising determining values of parameters of the parameterized beamforming process, including determining the transfer functions from each position of the plurality of positions to each microphone signal of the plurality of microphone signals.

14. The method of claim 13, wherein the determining of the values of the parameters of the parameterized beamforming process is performed prior to the receiving of the plurality of microphone signals.

15. The method of claim 13, wherein the determining of the values of the parameters of the parameterized beamforming process is based at least in part on an analytical acoustic model of the environment.

16. The method of claim 13, wherein the determining of the values of the parameters of the parameterized beamforming process is based on experimental data collection in an environment with physical characteristics corresponding to the environment in which the acoustic source is detected.

17. The method of claim 13, wherein the determining of the values of the parameters of the parameterized beamforming process comprises computing steering values between pairs of microphone signals for each position of the plurality of positions.

18. The method of claim 17, wherein computing the steering values between pairs of microphone signals comprises computing said steering values for a subset of fewer than all the pairs of microphone signals.

19. The method of claim 17, wherein computing the steering values between pairs of microphone signals comprises magnitude normalizing the steering values.

20. An acoustic processing system configured to perform all the steps of claim 1.

21. A non-transitory machine-readable medium comprising instructions stored thereon, where executing the instructions on a data processor cause said processor to perform all steps of claim 1.
